(19) United States
(12) Patent Application Publication
(10) Pub. No.: US 2021/0027074 A1
(43) Pub. Date: Jan. 28, 2021

(54) VEHICLE SYSTEM, SPACE AREA ESTIMATION METHOD, AND SPACE AREA ESTIMATION APPARATUS

(71) Applicant: DENSO CORPORATION, Kariya-city (JP)

(72) Inventors: Kunihiko CHIBA, Kariya-city (JP); Kentaro TESHIMA, Kariya-city (JP); Yusuke SEKIKAWA, Tokyo (JP); Koichiro SUZUKI, Yokohama-city (JP)

(21) Appl. No.: 17/039,215

(22) Filed: Sep. 30, 2020

Related U.S. Application Data
(63) Continuation of application No. PCT/JP2019/009463, filed on Mar. 8, 2019.

(30) Foreign Application Priority Data
Apr. 2, 2018 (JP) 2018-070850

(51) Int. Cl. G06K 9/00; G05D 1/02; G06T 7/50

(52) U.S. Cl. CPC G06K 9/00805; G06T 7/50; G05D 1/0251

(57) ABSTRACT

In a vehicle system, a space area estimation method, or a space area estimation apparatus, an outside of a vehicle is captured, and an image is generated. An object causing a blind angle in the image is recognized. A depth of the recognized object is estimated. An inside of a blind angle area formed by the object is estimated.

### CROSS REFERENCE TO RELATED APPLICATIONS

The present application is a continuation application of International Patent Application No. PCT/JP2019/009463 filed on Mar. 8, 2019, which designated the U.S. and claims the benefit of priority from Japanese Patent Application No. 2018-070850 filed on Apr. 2, 2018. The entire disclosures of all of the above applications are incorporated herein by reference.

### TECHNICAL FIELD

The present disclosure relates to a vehicle system, a space area estimation method, and a space area estimation apparatus.

### BACKGROUND

A vehicle system has been proposed. In a comparative example, a system includes a capture portion generating an image by capturing an outside of a vehicle. The capture portion captures a blind area of a side mirror of a blind angle area. The image generated by the capture portion is enlarged or reduced and displayed by a display device in a substantially same state.

### SUMMARY

In a vehicle system, a space area estimation method, or a space area estimation apparatus, an outside of a vehicle is captured, and an image is generated. An object causing a blind angle in the image is recognized. A depth of the recognized object is estimated. An inside of a blind angle area formed by the object is estimated.

### BRIEF DESCRIPTION OF DRAWINGS

The above and other features and advantages of the present disclosure will be more clearly understood from the following detailed description with reference to the accompanying drawings. In the drawings:

FIG. 1 is a block diagram showing a system of a vehicle system according to a first embodiment;

FIG. 2 is a block diagram schematically showing a circuit configuration of an ECU of FIG. 1;

FIG. 3 is one example of an image captured by a capture portion according to the first embodiment;

FIG. 4 is a view showing area data obtained by bird's eye view conversion according to the first embodiment;

FIG. 5 is a view showing area data in which labels are added to areas and the blind angle area is distinguished;

FIG. 6 is a view for describing one example of integration recognition according to the first embodiment;

FIG. 7 is a view showing area data in which an estimation result of a position of a pedestrian is added to FIG. 5;

FIG. 8 is a view for describing estimation of the position of the pedestrian according to the first embodiment;

FIG. 9 is a flowchart showing a generation process of the area data by the vehicle system according to the first embodiment;

FIG. 10 is a flowchart showing the integration recognition process by the vehicle system according to the first embodiment;

FIG. 11 is a flowchart showing an information presentation process by the vehicle system according to the first embodiment;

FIG. 12 is a flowchart showing an warning process by the vehicle system according to the first embodiment; and

FIG. 13 is a flowchart showing a vehicle travel control process by the vehicle system according to the first embodiment.

### DETAILED DESCRIPTION

In the comparative example, the blind angle area of the side mirror is captured. However, when an object exists within a captured angle, an inside of the blind angle area formed by the object cannot be sufficiently grasped.

One example of the present disclosure provides a vehicle system, a space area estimation method, and a space area estimation apparatus capable of appropriately grasping an inside of a blind angle area.

According to one example embodiment, a vehicle system for a vehicle includes: a capture portion that captures an outside of the vehicle and generates the image; and a blind angle area estimation portion that recognizes an object forming a blind angle in the image, estimates a depth of the object, and estimates an inside of a blind angle area formed by the object based on information of the estimated depth.

According to another example embodiment, a space area estimation method estimates a space area of an outside of a vehicle. The space area estimation method includes: acquiring an image of a captured outside; recognizing an object causing a blind angle in an acquired image, estimating a depth of a recognized object; and estimating an inside of a blind angle area formed by the object based on information of the depth of an estimated object.

Further, according to another example embodiment, a space area estimation apparatus is communicably connected to a capture portion mounted on a vehicle. The space area estimation apparatus includes an image acquisition portion that acquires an image of an outside of the vehicle from the capture portion; an operation circuit that is connected to the image acquisition portion and processes the image acquired by the image acquisition portion; and a memory that is connected to the operation circuit and stores information utilized by the operation circuit for processing the image. The operation circuit recognizes an object causing a blind angle in the image based on the information read from the memory, estimates a depth of a recognized object, and generates area data in which an inside of blind angle area formed by the object is estimated based on the information of an estimated depth of the object.

Further, according to another example embodiment, a space area estimation apparatus is communicatively connected to a capture portion mounted on a vehicle. The space area estimation apparatus includes: an image acquisition portion that acquires an image of an outside of the vehicle from the capture portion; an operation circuit that is connected to the image acquisition portion and processes the image acquired from the image acquisition portion; and a memory that is connected to the operation circuit and stores information utilized by the operation circuit for processing the image. The memory stores, as information for processing the image, a label database for adding a label to an object causing a blind angle in the image and a depth information database for estimating a depth of the object to which the label is added. The operation circuit generates area data in which an inside of a blind angle area formed by the object is estimated based on the information of the depth of the object estimated based on the label database and the depth information database.

According to a configuration of the present disclosure, in the image obtained by capturing the outside of the vehicle, the object causing the blind angle is recognized. The inside of the blind angle area formed by the object is estimated. When the inside of this blind angle area is estimated, the depth of the object is estimated and the information of the estimated depth is used. That is, the area of the blind angle area is an area from a front side of the capture portion to a position separated by a depth distance, and it may be possible to estimate the existence possibility of the object based on the area. It may be possible to estimate the existence possibility other than the object based on an area behind the area described above. Thereby, it may be possible to more appropriately grasp the inside of the blind angle area.

One embodiment will be described with reference to the drawings.

### First Embodiment

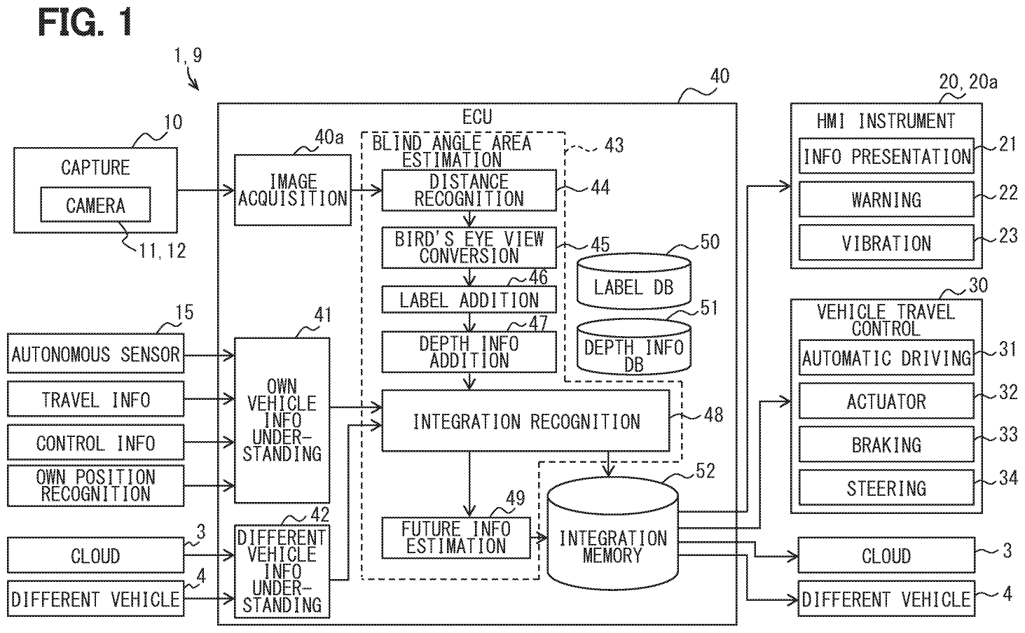

A vehicle system 9 is a system used for a vehicle 1, as shown in FIG. 1, and is mounted in the vehicle 1. Here, the vehicle 1 means the own vehicle in order to distinguish the own vehicle from a different vehicle 4. However, the own vehicle is merely described as a “vehicle”, and the different vehicle is described as the “different vehicle”. The vehicle system 9 includes a capture portion 10, an autonomous sensor portion 15, a HMI instrument portion 20, a vehicle travel controller 30, and an ECU (electronic control unit) 40 or the like.

The capture portion 10 include multiple cameras 11. Each of the cameras 11 includes a capture element, a lens, and a circuit unit 12 as a controller. The capture element is an element that converts light into electric signals by photoelectric conversion, and for example, a CCD image sensor or a CMOS image sensor can be employed. In order to form an image of a capture target on the capture element, the lens is placed between the capture target and the capture element.

The circuit unit 12 is an electronic circuit that includes at least one of a processor, a memory device (also referred to as memory), or an input output interface. The processor is an operation circuit that executes a computer program stored in the memory device. The memory device is provided by, for example, a semiconductor memory or the like, and is a non-transitory tangible storage medium for non-temporally storing the computer program that is readable by the processor. The circuit unit 12 is electrically connected to the capture element and thereby controls the capture element. The circuit unit 12 generates an image as data, and outputs the corresponding data as the electric signal to the ECU 40.

In such a manner, each of the cameras 11 of the capture portion 10 sequentially captures the outside of the vehicle 1 and generates the data of the image. In the present embodiment, each of the multiple cameras 11 captures the outside of the vehicle 1 in a different direction. The multiple cameras 11 includes a camera 11 that captures a forward area of the vehicle 1 in the outside of the vehicle 1.

The autonomous sensor portion 15 detects, so as to assist the capture portion 10, a movement object such as the pedestrian in the outside of the vehicle 1 or the different vehicle 4 and a stationary object such as a fallen object on a road, a traffic signal, a guardrail, a curbstone, a road sign, a road marking or a lane marker. The autonomous sensor portion 15 includes at least one autonomous sensor such as, for example, a lidar unit, a millimeter wave radar, or a sonar. Since the autonomous sensor portion 15 can communicate with the ECU 40, the autonomous sensor portion 15 outputs the detection result data of each autonomous sensor portion 15 as the electric signal to the ECU 40.

The HMI instrument portion 20 mainly includes an instrument group for implementing an HMI (human machine interface). The HMI instrument portion 20 includes an information presentation portion 21, a warning portion 22, and a vibration portion 23.

The information presentation portion 21 mainly presents visual information to an occupant of the vehicle 1. The information presentation portion 21 includes, for example, at least one display of a combination meter including a display instrument that displays the image, a head up display that projects the image on a windshield or the like of the vehicle 1 and displays a virtual image, a navigation display that can display a navigation image, or the like. Since the information presentation portion 21 can communicable with the ECU 40, the information presentation portion 21 provides the visual information in accordance with an input of the electric signal from the ECU 40.

The warning portion 22 executes warning to the occupant of the vehicle 1. The warning portion 22 includes, for example, at least one sound oscillation device of a speaker, a buzzer, or the like. Since the warning portion 22 can communicate with the ECU 40, the warning portion 22 executes the warning in accordance with input of the electric signal from the ECU 40.

The vibration portion 23 provides the information or the warning to the occupant of the vehicle 1 by vibration. The information may be also referred to as “INFO” in the drawings. The vibration portion 23 includes, for example, at least one actuator of an actuator that vibrates a steering wheel of the vehicle 1, an actuator that vibrates a seat on which the occupant seats, or the like. Since the vibration portion 23 can communicate with the ECU 40, the vibration portion 23 executes vibration in accordance with the input of the electric signal from the ECU 40.

In the HMI instrument portion 20, a circuit unit 20a can be placed as the controller that controls the information presentation portion 21, the warning portion 22, and the vibration portion 23. The circuit unit 20a is an electronic circuit that includes at least one of a processor, a memory device, or an input output interface. The processor is an operation circuit that executes a computer program stored in a memory device. The memory device is provided by, for example, a semiconductor memory or the like, and is a non-transitory tangible storage medium for non-temporally storing the computer program that is readable by the processor. The circuit unit 20a can convert the electric signal from the ECU 40 into the signal in accordance with the information presentation portion 21, the warning portion 22, and the vibration portion 23, and can share a part of the information presentation process and the warning process.

The vehicle travel controller 30 includes, as main, an electronic circuit that includes at least one of the processor, the memory device, or the input output interface. The processor is an operation circuit that executes the computer program stored in the memory device. The memory device is provided by, for example, a semiconductor memory or the like, and is a non-transitory tangible storage medium for non-temporally storing the computer program that is readable by the processor. Since the vehicle travel controller 30 can communicate with the ECU 40, a drive device of the vehicle 1, a braking device, and the steering device, the vehicle travel controller 30 receives the electric signal from the ECU 40, and outputs the electric signal to the drive device of the vehicle 1, the braking device, and the steering device.

The vehicle travel controller 30 includes an automatic driving controller 31, a drive controller 32, a braking controller 33, and a steering controller 34 as a function block achieved by execution of the computer program.

The automatic driving controller 31 has an automatic driving function that can executes, at least, a part of the driving operation of the vehicle 1 in place of the driver as the occupant. While the automatic driving function operates, the automatic driving controller 31 acquires information useful for automatic driving from an integration memory 52 of the ECU 40, uses the corresponding information, and executes the automatic driving control of the vehicle 1. Specifically, the automatic driving controller 31 controls the drive device of the vehicle 1 via the drive controller 32, controls the braking device of the vehicle 1 via the braking controller 33, and controls steering device via the steering controller 34. The automatic driving controller 31 controls the traveling of the vehicle 1 by coordinating the drive device, the braking device, and the steering device with each other, and avoids a risk that may be encountered by the corresponding vehicle 1 depending on a situation of the outside of the vehicle 1.

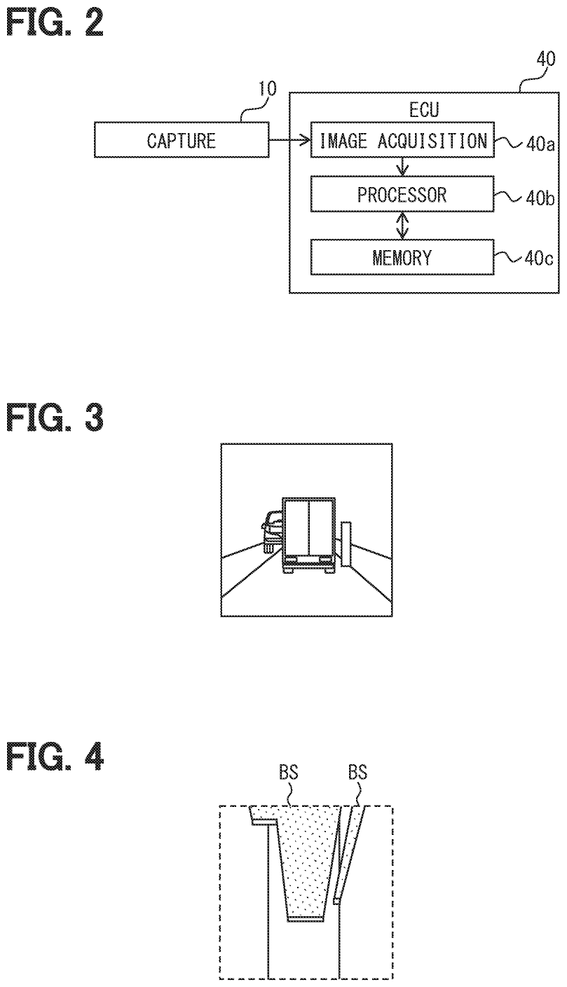

The ECU 40 functions as a space area estimation apparatus that estimates a space area of the outside of the vehicle 1. As shown in FIG. 2, the ECU 40 mainly includes an electronic circuit that includes at least one of a processor 40b, a memory device 40c, and the input output interface (for example, an image acquisition portion 40a). The processor 40b is an operation circuit that executes the computer program stored in the memory device 40c. The memory device 40c is provided by, for example, a semiconductor memory or the like, and is a non-transitory tangible storage medium for non-temporally storing the computer program that is readable by the processor 40b and a database. At least one of the computer program can be replaced with an artificial intelligence algorithm using a neural network. In the present embodiment, a part of the functions is implemented by the neural network.

As shown in FIG. 1, the ECU 40 can communicate with the capture portion 10, the autonomous sensor portion 15, the HMI instrument portion 20, and the vehicle travel controller 30, as described above. In addition, the ECU 40 can acquire the travel information of the vehicle 1, the control information of the vehicle 1, own position information of the vehicle 1, information from a cloud 3, and information from the different vehicle 4 based on the input of the electric signal via the communication. Furthermore, the ECU 40 can present information to the cloud 3 and the different vehicle 4. Here, the cloud 3 means one of a network implemented by cloud computing and a computer connected to the network or means both of the network and the computer. The cloud 3 can share the data, and receive various services for the vehicle 1.

In the present embodiment, the communication between the ECU 40 and each element is provided by a vehicle interior network such as, for example, CAN (registered trademark), or a public communication network such as, for example, a mobile phone network or an internet. However, various suitable communication methods may be employed in regardless of a wire communication or wireless communication.

In FIG. 1, the cloud 3 is shown in two places for convenience. However, these may be the same clouds or different clouds. This similar applies to the different vehicle 4. In the present embodiment, it is assumed that these are same, and the description will be continued with the same reference numerals. A different reference numeral or no reference numeral is applied to another vehicle different from the different vehicle 4 that communicates with the vehicle 1.

The ECU 40 includes an own vehicle information understanding portion 41, a different vehicle information understanding portion 42, and a blind angle area estimation portion 43, as the function block. The ECU 40 includes the image acquisition portion 40a. The ECU 40 includes a label database 50 and a depth information database 51 as the database stored in the memory device 40c, for example. The ECU 40 includes the integration memory 52 defined by a memory area that occupies a part of area of the memory device 40c described above.

The own vehicle information understanding portion 41 sequentially acquires the information from the autonomous sensor portion 15, the travel information of the own vehicle, the control information and the own position information of the own vehicle, that is, information regarding the own vehicle via the input output interface, organizes these information, and understand the information.

The different vehicle information understanding portion 42 sequentially acquires the information from the cloud 3 and the information from the different vehicle 4, that is, information regarding the different vehicle via an input output interface, organizes these information, and understands the information.

The image acquisition portion 40a is an input output interface that acquires the image data from the capture portion 10, and a signal conversion circuit.

The blind angle area estimation portion 43 estimates each area of the outside of the vehicle 1 by coordinating the information understood by the own vehicle information understanding portion 41 and the information understood by the different vehicle information understanding portion 42 with the image data, as main, acquired from the capture portion 10.

The blind angle area estimation portion 43 includes a distance recognition portion 44, a bird's eye view conversion portion 45, a label addition portion 46, a depth information addition portion 47, an integration recognition portion 48, and a future information estimation portion 49, as a sub-function block.

The distance recognition portion 44 recognizes each object reflected in the image acquired from the capture portion 10. As shown in FIG. 3, a back side of the object is not reflected in the image unless the object is transparent. Therefore, each object causes the blind angle in the image. The distance recognition portion 44 estimates a distance from the camera 11 to each object. In other words, the distance recognition portion 44 infers the distance from the camera 11 to each object. The blind angle may mean an area that is not reflected in the image due to the object.

As shown in FIG. 4, the bird's eye view conversion portion 45 executes the bird's eye view conversion of converting the image acquired from the capture portion 10 into data in which the outside of the vehicle 1 is shown in the bird's eye viewpoint, based on the distance to each object estimated by the distance recognition portion 44. This data is area data including two-dimensional coordinate information excluding coordinate information of a height direction corresponding to the gravity direction. Along with the bird's eye view conversion, a blind angle area BS is defined as an area corresponding to the blind angle formed by each object in the area data.

The bird's eye view conversion compresses three-dimensional information into two dimensional information, and therefore it may be possible to reduce the amount of data processed by the ECU 40. The load on the process of the ECU 40 is reduced, and it may be possible to improve a process speed. In addition, it may be possible to execute a process of using outside information in more directions.

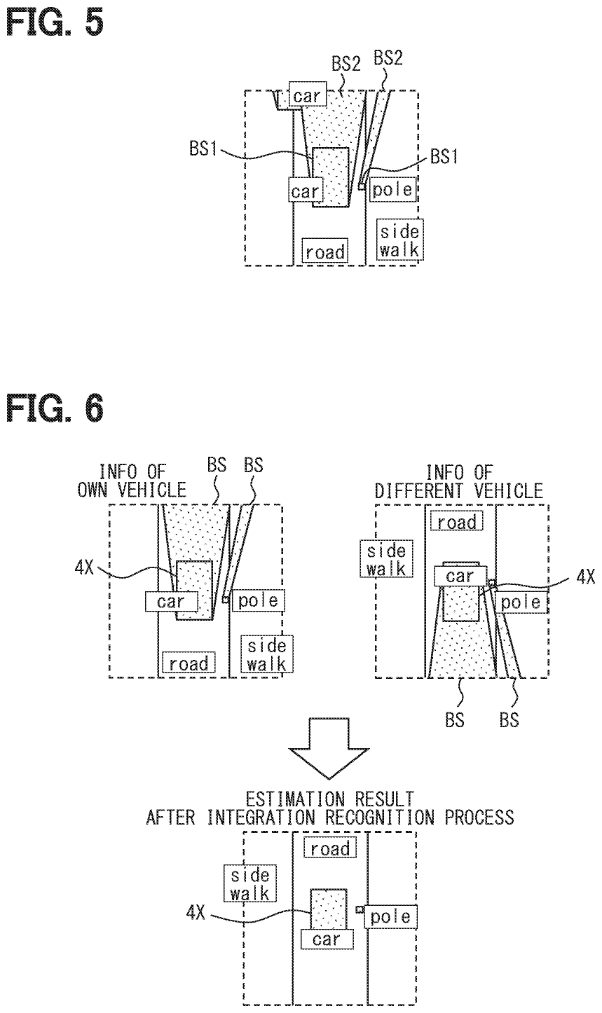

As shown in FIG. 5, the label addition portion 46 adds the label to each object recognized by the distance recognition portion 44. Here, this label is a symbol in accordance with the type of the object such as, for example, a pedestrian, a car, a vehicle road, a sidewalk, or a pole. The label is added to the object with reference to the label database 50. In the label database 50, for example, the image and the type of object can be associated by machine learning executed in advance. The person can input the data to the label database 50 in advance. Instead of the label database 50, a label library having a library format may be employed.

The depth information addition portion 47 adds depth information to each object based on the label added by the label addition portion 46. Specifically, the depth information addition portion 47 refers the depth information database 51, acquires the depth information in accordance with the label added to the object, and thereby can estimate the depth of the object. In the depth information database 51, for example, the depth and the type of object can be associated by machine learning executed in advance. The person can input the data to the label database 50 in advance. Instead of the depth information database 51, the depth information having the library format may be employed. The depth may also mean, for example, a distance of the object in a traveling direction of the vehicle. Here, the term of “depth” may mean a length of the object in parallel with a direction from the vehicle 4 or the camera 11 to the object.

As shown in FIG. 5, the label and the depth information are added to the area data described above. Thereby, in the corresponding data, the blind angle area BS can be identified as an area BS1 where an existence possibility of the object is high or an area BS2 behind the corresponding object. The area BS1 may be also referred to as a first area. The area BS2 may be also referred to as a second area. The area BS2 may be an area other than the area BS1 in the blind angle area BS.

The integration recognition portion 48 integrates the information understood by the own vehicle information understanding portion 41, the information understood by the different vehicle information understanding portion 42, and the image captured by the capture portion 10 in the past, and recognizes them in addition to the area data obtained by the distance recognition portion 44, the bird's eye view conversion portion 45, the label addition portion 46, and the depth information addition portion 47. Thereby, the integration recognition portion 48 improves an estimation accuracy in the inside of the blind angle area BS.

The integration recognition portion 48 adds the information understood by the own vehicle information understanding portion 41 to the result. For example, when the autonomous sensor portion 15 detects a part of the inside of the blind angle area BS by the capture portion 10, the detected area can be estimated. Therefore, it may be possible to substantially narrow the corresponding blind angle area BS. Then, the integration recognition portion 48 can reflect the result to which the above information is added in the area data.

The integration recognition portion 48 adds the information understood by the different vehicle information understanding portion 42 to the result. For example, when the capture portion 10 mounted in the different vehicle 4 recognizes a part of the inside of the blind angle area BS due to the vehicle 1, the recognized area can be estimated. Therefore, it may be possible to substantially narrow the corresponding blind angle area BS. Then, the integration recognition portion 48 can reflect the result to which the above information is added in the area data.

For example, as shown in FIG. 6, the area data obtained from the image of the front of the vehicle 1 captured by the capture portion 10 of the vehicle 1 and the area data obtained from the image of the rear of the different vehicle 4 captured by the capture portion 10 of the different vehicle 4 located in front of the corresponding vehicle 1 are integrated. Thereby, even when the different vehicle 4X and the object such as the pole exist between the vehicle 1 and the different vehicle 4, the blind angle area BS is narrowed. It may be possible to obtain the highly accurate estimation result.

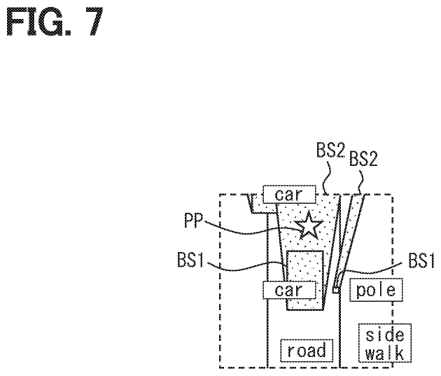

The integration recognition portion 48 adds the information to the area data obtained from the image captured by the capture portion 10 in the past. For example, when the pedestrian recognized in the past area data and gradually moving towards the blind angle area BS is not recognized in the current area data, the integration recognition portion 48 calculate a position PP where the existence possibility of the pedestrian inside the blind angle area BS is high based on the past movement speed of the pedestrian. The integration recognition portion 48 can add the information of the position PP where the existence possibility of the pedestrian is high to the area data, as shown in FIG. 7.

The future information estimation portion 49 predicts the feature in cooperation with the integration recognition portion 48. For example, the future information estimation portion 49 can estimate a time point when the pedestrian appears from the inside of the blind angle area BS to the outside of the blind angle area BS, based on the position PP where the existence possibility of the pedestrian is high inside the blind angle area BS in the current area data, the past movement speed of the above pedestrian, and the past movement direction of the above pedestrian.

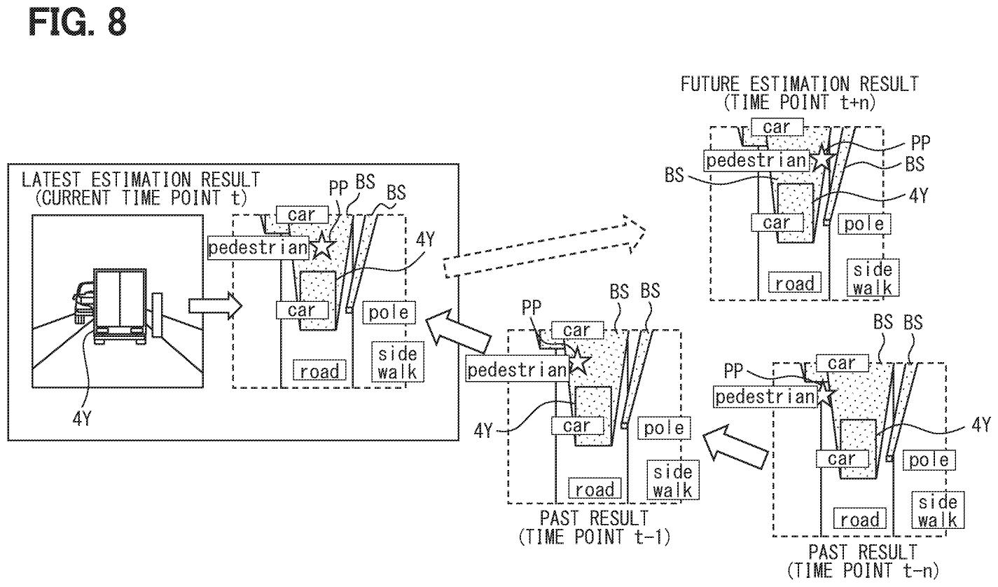

As shown in FIG. 8, a case where the different vehicle 4Y in front of the vehicle 1 stops due to, for example, a red traffic signal or the like and the corresponding different vehicle 4Y forms the blind angle area BS is assumed. The movement speed and the movement direction of the pedestrian are calculated based on the position PP of the pedestrian recognized in the outside of the blind angle area BS in area data at a past time point t-n and area data at a past time point t−1. Even when the pedestrian is not recognized in an image at a current time point t, the position where the existence possibility of the pedestrian is high inside the blind angle area BS is estimated based on the calculated movement speed and the movement direction. Further, the pedestrian appears again outside the blind angle area BS at a time point t+n in the feature.

The area data to which the estimation result is added is stored in the integration memory 52 and accumulated, as shown in FIG. 1.

The integration recognition portion 48 determines whether the warning by the warning portion 22 of the HMI instrument portion 20 and the vibration by the vibration portion 23 are necessary based on the existence possibility of the pedestrian or the like.

The blind angle area estimation portion 43 recognizes the object causing the blind angle in the image, estimates the depth of the object, and estimates the inside of the blind angle area BS formed by the corresponding object based on the estimated depth information. When a part of the blind angle area estimation portion 43 is provided by using the neural network, at least a part of each sub-function block may not be defined by the blind angle area estimation portion 43. For example, the blind angle area estimation portion 43 may compositely or comprehensively configure a function corresponding to each sub-function by using the neural network. In FIGS. 4 to 8, a part corresponding to the blind angle area BS is shown with dot hatching.

The area data stored in the integration memory 52 can be output to the HMI instrument portion 20, the vehicle travel controller 30, the cloud 3, and the different vehicle 4 as the electric signal using the communication.

The information presentation portion 21 of the HMI instrument portion 20 is the output destination of the area data and acquires data necessary for presentation of the information, for example, new area data or the like from the integration memory 52 of the ECU 40. The information presentation portion 21 presents the acquired area data as visual information obtained by visualizing the acquired area data to the occupant of the vehicle 1. For example, one of the display instrument of the combination meter, the head up display, and the navigation display displays, as the image, the area data in a state of the bird's eye view as the visual information that is a two dimensional map form, as shown in FIG. 7.

When the warning is determined to be necessary, the warning portion 22 of the HMI instrument portion 20 acquires the content of the warning via the integration memory 52 of the ECU 40. The warning portion 22 executes warning to the occupant of the vehicle 1. The warning provided by the voice emitted from the speaker or the warning provided by the warning sound emitted from the buzzer is executed.

When the vibration is determined to be necessary, the vibration portion 23 of the HMI instrument portion 20 acquires the content of the vibration via the integration memory 52 of the ECU 40. The vibration portion 23 generates the vibration in a mode in which the occupant of the vehicle 1 can sense the vibration. The vibration portion 23 is preferably linked to the warning by the warning portion 22.

Whether the warning and the vibration are necessary is determined based on the information estimated by the blind angle area estimation portion 43, more specifically, the area data. This determination includes the estimation information of the inside of the blind angle area BS.

For example, when the object forming the blind angle area BS is the different vehicle in a stationary state, the blind angle area estimation portion 43 identifies an area inside the blind angle area BS as the area BS1 where the existence possibility of the corresponding vehicle is high, based on the depth information of the corresponding different vehicle. The area BS1 where the existence possibility of the different vehicle 4Y is high is estimated to be an area where the existence possibility of the pedestrian is low.

When the area where the existence possibility of the pedestrian is high or the area where the existence possibility of the pedestrian cannot be sufficiently denied exists in, for example, an area between the vehicle 1 and a position away from the vehicle 1 by a predetermined distance, the warning and the vibration are determined to be necessary. Therefore, in a case where the area inside the blind angle area BS is not identified as the area BS1 where the existence possibility of the object is high and the area BS2 behind the corresponding object, the warning and the vibration are determined to be necessary at a time when the warning range described above includes the corresponding blind angle area BS.

However, in a situation where an area of the blind angle area BS is identified as the area BS1 in which the existence possibility of the corresponding different vehicle is high and this area is estimated to be the area in which the existence possibility of the pedestrian is low, even when the warning range includes the corresponding area BS1, it is determined that the warning to the pedestrian regarding the area BS1 is unnecessary. In this way, the warning portion 22 is restricted to execute the warning, and the troublesomeness of the unnecessary warning is suppressed.

The automatic driving controller 31 of the vehicle travel controller 30 is the output destination of the area data, and acquires data necessary for the automatic driving, for example, the latest area data or the like from the integration memory 52 of the ECU 40. The automatic driving controller 31 controls traveling of the vehicle 1 by using the acquired data.

For example, when the different vehicle of which speed is slower than the vehicle 1 is recognized as the object forming the blind angle area BS in front of the vehicle 1, the automatic driving controller 31 determines whether to execute traveling for overtaking the corresponding different vehicle by automatic driving control. Then, the blind angle area estimation portion 43 estimates the area BS1 in which the existence possibility of the corresponding different vehicle is high inside the blind angle area BS based on the depth information of the corresponding different vehicle. Therefore, a position of a forward end of the corresponding different vehicle inside the blind angle area is estimated.

The automatic driving controller 31 determines whether the vehicle 1 can overtake the different vehicle and enter an area in front of the forward end of the corresponding different vehicle. When the determination is positive, the traveling for overtaking the different vehicle is executed by the automatic driving. When the determination is negative, the execution of the traveling for overtaking the different vehicle is stopped.

The estimation result of the future information estimation portion 49 is added to the determination by the automatic driving controller 31, and thereby it may be possible to further improve a determination validity.

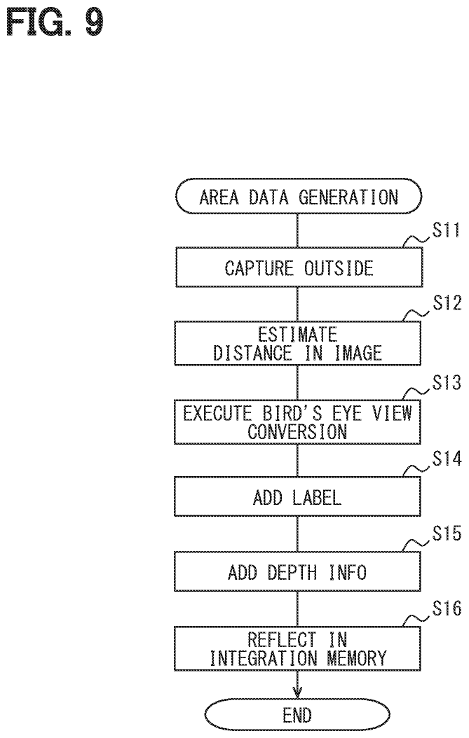

A process by the vehicle system 9 according to the first embodiment will be described with reference to flowcharts of FIGS. 9 to 13. The process of each flowchart is, for example, sequentially executed at a predetermined cycle. In each flowchart, a generation process of the area data, an integration recognition, an information presentation process, a warning process, and vehicle travel control process may be sequentially executed after the different process is completed, and may be simultaneously executed in parallel from each other if possible. The generation process of the area data will be described with reference to the flowchart of FIG. 9.

In S11, the capture portion 10 captures the outside of the vehicle 1, and generates the image. After the process in S11, the process shifts to S12.

In S12, the distance recognition portion 44 estimates the distance to each object of the image captured by the capture portion 10 in S11. After the process in S12, the process shifts to S13.

In S13, the bird's eye view conversion portion 45 executes the bird's eye view conversion of converting the image acquired from the capture portion 10 into the data in which the outside of the vehicle 1 is shown in the bird's eye viewpoint, based on the depth estimation result. After the process in S13, the process shifts to S14.

In S14, the label addition portion 46 adds the label to each object recognized by the distance recognition portion 44. After the process in S14, the process shifts to S15.

In S15, the depth information addition portion 47 adds the depth information to each object based on the label added by the label addition portion 46. After the process in S15, the process shifts to S16.

In S16, the area data corresponding to the estimation of the inside of the blind angle area BS is generated. The corresponding area data is reflected in the integration memory 52. After S16, the generation process of the area data ends.

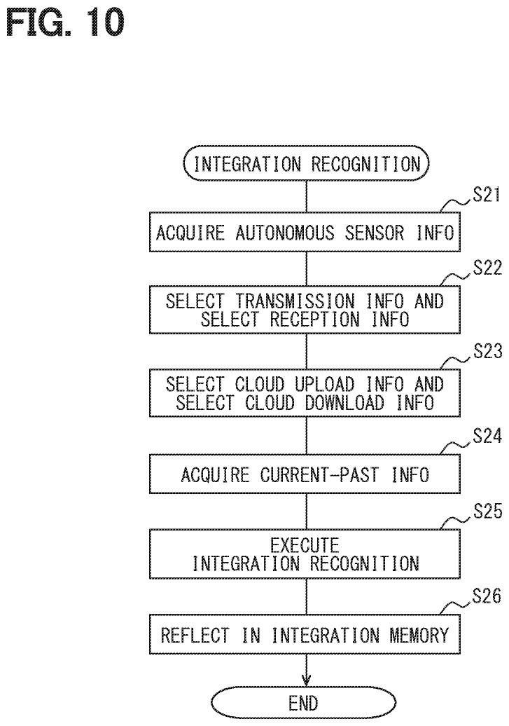

The integration recognition process will be described with reference to the flowchart of FIG. 10. The order of the processes in S21 to S24 can be appropriately changed, and may be simultaneously executed if possible.

In S21, the integration recognition portion 48 acquires the information from the autonomous sensor portion 15 via the own vehicle information understanding portion 41. After the process in S21, the process shifts to S22.

In S22, the integration recognition portion 48 selects the information transmitted from the integration memory 52 to the different vehicle 4 by inter-vehicle communication, and transmits the selected information as the data to the corresponding different vehicle 4. Along with this, the integration recognition portion 48 selects the information received from the different vehicle 4 via the different vehicle information understanding portion 42, and receives the selected information as the data from the corresponding different vehicle 4. After the process in S22, the process shifts to S23.

In S23, the integration recognition portion 48 selects the information uploaded from the integration memory 52 to the cloud 3, and uploads the selected information to the corresponding cloud 3. Along with this, the integration recognition portion 48 selects the information downloaded from the cloud 3 via the different vehicle information understanding portion 42, and downloads the selected information. After the process in S23, the process shifts to S24.

In S24, the integration recognition portion 48 acquires the latest information (in other words, the current information), more specifically, the latest area data or the like from the integration memory 52. If necessary, the integration recognition portion 48 acquires the past information (in other words, information before the current), more specifically, the past area data or the like from the integration memory 52. After the process in S24, the process shifts to S25.

In S25, the integration recognition portion 48 integrates the data acquired in S21 to S24 and recognizes the data. Thereby, the estimation accuracy in the inside of the blind angle area BS is improved. After the process in S25, the process shifts to S26.

In S26, the result in S25 is reflected in the integration memory 52. After S26, the integration recognition process ends.

For example, when at least a part of the blind angle area estimation portion 43 is provided by using the neural network, at least a part of the processes in S11 to S16 and S21 to S26 may be compositely or comprehensively processed.

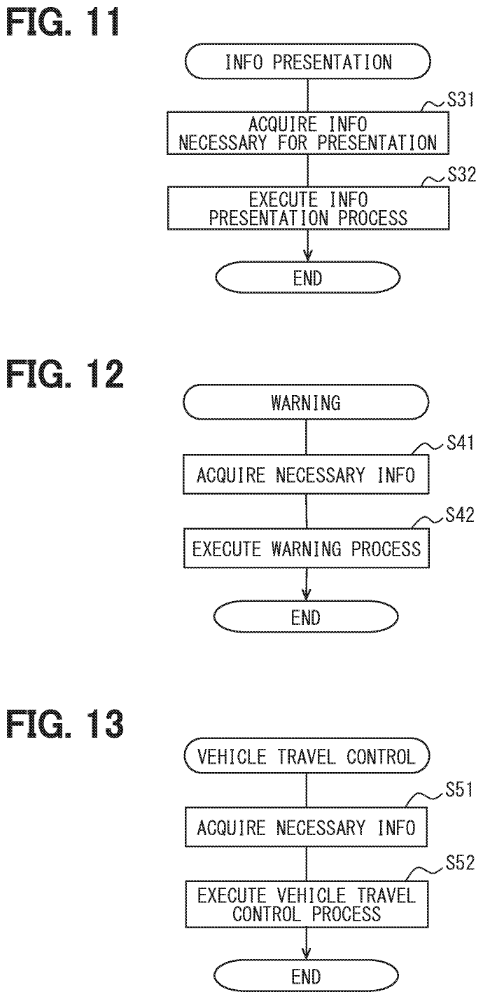

The information presentation process will be described with reference to the flowchart of FIG. 11.

In S31, the information presentation portion 21 acquires the data necessary for the presentation of the information, for example, the latest area data or the like from the integration memory 52 of the ECU 40. After the process in S31, the process shifts to S32.

In S32, in the information presentation process, the information presentation portion 21 visualizes the latest area data, and presents the visual information to the occupant. After S32, a series of processes ends.

The warning process will be described with reference to the flowchart of FIG. 12.

In S41, when the warning is determined to be necessary by using the integration memory 52 of the ECU 40, the warning portion 22 acquires the warning content via the integration memory 52 of the ECU 40. After the process in S41, the process shifts to S42.

In S42, in the warning process, the warning portion 22 emits the voice or the warning sound to the occupant based on the content acquired in S41, and executes the warning. After S32, a series of processes ends.

The vehicle travel control process will be described with reference to the flowchart of FIG. 13.

In S51, the automatic driving controller 31 acquires the data necessary for the automatic driving, for example, the latest area data or the like from the integration memory 52 of the ECU 40. After the process in S51, the process shifts to S52.

In S52, the automatic driving controller 31 executes the vehicle travel control process. More specifically, the automatic driving controller 31 controls the traveling of the vehicle 1 based on the area data. After S52, a series of processes ends.

One example of the operation effect of the first embodiment will be described.

The object causing the blind angle is recognized in the image obtained by capturing the outside of the vehicle 1 with used of the capture portion 10. The inside of the blind angle area BS formed by the corresponding object is estimated. When the inside of this blind angle area BS is estimated, the depth of the object is estimated, and the estimated depth information is used. That is, the area BS1 of the blind angle area BS is an area from a front side of the capture portion 10 to a position separated by a depth distance, and it may be possible to estimate the existence possibility of the corresponding object based on the area BS1. That is, the area BS2 may be an area behind the area BS1. It may be possible to estimate the existence possibility other than the corresponding object based on the area BS2. In this way, it may be possible to more appropriately grasp the inside of the blind angle area BS.

Based on the depth information, the area data is generated. In the area data, the blind angle area BS includes the area BS1 in which the existence possibility of the object is high and the area BS2 behind the object. The area BS1 is distinguished from the area BS2. Since each of the distinguished areas BS1 and BS2 inside the blind angle area BS can be used as the data, it may be possible to increase a value of the estimation result.

The information presentation portion 21 presents the visual information obtained by visualizing the area data. Since the space area can be immediately understood based on the visual information, the occupant of the vehicle 1 can easily grasp the estimated inside of the blind angle area BS.

The information presentation portion 21 presents, as the visual information, the bird's eye view showing the outside of the vehicle 1 in the bird's eye viewpoint. Since the bird's eye view eases the understanding of a distance relation as two-dimensional information, the occupant of the vehicle 1 can easily grasp the estimated inside of the blind angle area BS.

Based on the information of the estimated inside of the blind angle area BS, the warning regarding the corresponding blind angle area BS is performed to the occupant of the vehicle 1. Such a warning enables the occupant to pay attention to the inside of the blind angle area BS.

The blind angle area estimation portion 43 restricts the warning to the pedestrian in the area BS1 in which the existence possibility of the pedestrian is negatively estimated inside the blind angle area BS. In this mode, it may be possible to prevent the occupant of the vehicle 1 from paying excessive attention to the area BS1 in which the existence possibility of the pedestrian is negatively estimated, and reduce the troublesomeness of the warning.

The traveling of the vehicle 1 is controlled based on the information of the estimated inside of the blind angle area BS. In this mode, it may be possible to prevent a situation where it is determined that no object exists even in a state in which the inside of the blind angle area BS is unknown and an irresponsible traveling is control is executed. Further, it may be possible to prevent a situation where the more appropriate traveling control is performed in a state in which the object is determined to exist in the entire of corresponding blind angle area BS. Therefore, it may be possible to improve the validity of the automatic driving control.

The vehicle travel controller 30 determines whether to cause the vehicle 1 to travel toward the area BS2 behind the object. Based on such a determination, it may be possible to more appropriately control the traveling of the vehicle 1.

The inside of the blind angle area BS is estimated based on both of the latest image and the past image. That is, since the inside of the blind angle area BS in the latest image is estimated based on the object shown in the past image, it may be possible to improve the estimation accuracy.

The inside of the blind angle area BS is estimated based on both of the image of the vehicle 1 and the information from the different vehicle 4. That is, although an area is the blind angle area for the capture portion 10 of the vehicle 1, the area may not be the blind angle area for the different vehicle 4. Therefore, it may be possible to substantially narrow the blind angle area BS. As the result, the estimation accuracy of the inside of the blind angle area BS is improved. It may be possible to more accurately grasp the outside of the vehicle 1.

The inside of the blind angle area BS is estimated by using both of the image and the information from autonomous sensor portion 15, that is, by sensor fusion. Therefore, the detection information of the blind angle area BS from the autonomous sensor portion 15 is considered, and it may be possible to improve the estimation accuracy of the inside of the blind angle area BS.

The ECU 40 is communicably connected to the different vehicle 4 or the cloud 3, and transmits the area data of the estimated inside of the blind angle area BS to the different vehicle 4 or the cloud 3. Accordingly, the information in which the vehicle 1 is estimated as the subject can be shared with the different subject, and the value of the estimation result can be improved.

The space area estimation method includes an image acquisition step (or section) of acquiring an image obtained by capturing the outside of the vehicle 1, a recognition step of recognizing the object causing the blind angle in the image acquired in the image acquisition step, a depth estimation step of estimating the depth of the object recognized in the recognition step, and a blind angle estimation step of estimating the inside of the blind angle area BS formed by the corresponding object based on the depth information of the object estimated in the depth estimation step. That is, the area BS1 of the blind angle area BS is an area from an image capture side to the position separated by the depth distance, and it may be possible to estimate the existence possibility of the corresponding object based on the area BS1. That is, the area BS2 may be an area behind the area BS1. It may be possible to estimate the existence possibility other than the corresponding object based on the area BS2. Thereby, it may be possible to more appropriately grasp the inside of the blind angle area BS.

### OTHER EMBODIMENTS

Although one embodiment has been described, the present disclosure should not be limited to the above embodiment and may be applied to various other embodiments within the scope of the present disclosure.

According to a first modification embodiment, when an electronic circuit including the ECU 40 and the vehicle travel controller 30 or the like that are hardware is provided, the electronic circuit can be provided by a digital circuit or an analog circuit including multiple logic circuits.

According to a second modification embodiment, a part of the functions of the vehicle travel controller 30 or the HMI instrument portion 20 may be implemented by the ECU 40. In this example, the ECU 40 and the vehicle travel controller 30 may be integrated into one device. On the contrary, a part of the functions of the ECU 40 may be implemented by the vehicle travel controller 30 or the HMI instrument portion 20.

According to a third modification example, the vehicle system 9 may not include the HMI instrument portion 20. In this example, the estimation result by the blind angle area estimation portion 43 may be mainly used for the traveling control of the vehicle 1 by the automatic driving controller 31.

According to a fourth modification example, the vehicle system 9 may not include the vehicle travel controller 30. In this example, the estimation result by the blind angle area estimation portion 43 may be mainly used for at least one of provision of the visual information by the HMI instrument portion 20, the warning, or the vibration.

According to a fifth embodiment, the ECU 40 may not exchange the information with at least one of the cloud 3 or the different vehicle 4.

According to a sixth embodiment, the area data may be data regarding three-dimensional coordinate information. That is, the bird's eye view conversion portion 45 does not execute the bird's eye view conversion of the image acquired from the capture portion 10, and, alternatively, the three-dimensional space may be recognized from the image acquired from the capture portion 10. In this case, for example, a stereo camera may be used to improve the recognition accuracy of this three-dimensional space.

According to a seventh embodiment, a target of the warning implemented by the warning portion 22 and a target of regulation of the warning are not limited to the pedestrian, and may be various obstacles.

While various embodiments, configurations, and aspects of the vehicle system, the space area estimation method, and the space area estimation apparatus according to the present disclosure have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects of the present disclosure.

The control and the method therefor which have been described in the present disclosure may be also implemented by a dedicated computer which constitutes a processor programmed to execute one or more functions concretized by computer programs. Alternatively, the controller and the method described in the present disclosure may be implemented by a special purpose computer configured as a processor with a special purpose hardware logic circuits. Alternatively, the controller and the method described in the present disclosure may be implemented by one or more dedicated computers configured by a combination of a processor executing a computer program and one or more hardware logic circuits. The computer programs may be stored, as instructions to be executed by a computer, in a tangible non-transitory computer-readable medium.

It is noted that a flowchart or the process of the flowchart in the present disclosure includes multiple steps (also referred to as sections), each of which is represented, for instance, as S11. Further, each step can be divided into several sub-steps while several steps can be combined into a single step.

1. A vehicle system for a vehicle comprising:
a capture portion configured to
capture an outside of the vehicle and
generate an image; and
a blind angle area estimation portion configured to
recognize an object causing a blind angle in the image,
estimate a depth of the object, and
estimate an inside of a blind angle area formed by the object based on information of an estimated depth.

2. The vehicle system according to claim 1, wherein:
the blind angle area estimation portion is configured to generate area data based on the information of the depth;
the area data includes a first area where an existence possibility of the object is high and a second area behind the object; and
the blind angle area estimation portion is configured to distinguish between the first area and the second area based on the information of the depth.

3. The vehicle system according to claim 2, further comprising:
an information presentation portion configured to present visual information obtained by visualizing the area data.

4. The vehicle system according to claim 3, wherein:
the information presentation portion is configured to present, as the visual information, a bird's eye view showing the outside of the vehicle in a bird's eye viewpoint.

5. The vehicle system according to claim 1, wherein:
the blind angle area estimation portion is configured to execute bird's eye view conversion of converting the image into data showing the outside in a bird's eye viewpoint, and estimate the blind angle area.

6. The vehicle system according to claim 1, further comprising:
a warning portion configured to execute warning regarding the blind angle area to an occupant of the vehicle based on the information estimated by the blind angle area estimation portion.

7. The vehicle system according to claim 6, wherein:
when the blind angle area includes an area where an existence possibility of a pedestrian is negatively estimated, the warning executed by the warning portion to the pedestrian is restricted.

8. The vehicle system according to claim 1, further comprising:
a vehicle travel controller configured to control traveling of the vehicle based on the information estimated by the blind angle area estimation portion.

9. The vehicle system according to claim 8, wherein:
the vehicle travel controller is configured to determine whether to cause the vehicle to travel toward an area behind the object.

10. The vehicle system according to claim 1, wherein:
the capture portion is configured to sequentially capture the image; and
the blind angle area estimation portion is configured to estimate an inside of the blind angle area based on both of a latest image and a past image.

11. The vehicle system according to claim 1, further comprising:
a different vehicle information understanding portion configured to acquire information from a different vehicle,
wherein
the blind angle area estimation portion is configured to estimate an inside of the blind angle area based on both of the image and the information from the different vehicle.

12. The vehicle system according to claim 1, further comprising:
an autonomous sensor configured to detect the outside,
wherein:
the blind angle area estimation portion is configured to estimate an inside of the blind angle area based on both of the image and information from the autonomous sensor.

13. A space area estimation method for estimating a space area of an outside of a vehicle, the space area estimation method comprising:
acquiring an image of a captured outside;
recognizing an object causing a blind angle in an acquired image;
estimating a depth of a recognized object; and
estimating an inside of a blind angle area formed by the object based on information of an estimated depth of the object.

14. A space area estimation apparatus communicably connected to a capture portion mounted on a vehicle, the space area estimation apparatus comprising:
an image acquisition portion configured to acquire an image of an outside of the vehicle from the capture portion;
an operation circuit that is connected to the image acquisition portion and is configured to process the image acquired by the image acquisition portion; and
a memory that is connected to the operation circuit and stores information utilized by the operation circuit for processing the image,
wherein:
the operation circuit is configured to
recognize an object causing a blind angle in the image based on the information read from the memory,
estimate a depth of a recognized object, and
generate area data in which an inside of a blind angle area formed by the object is estimated based on the information of an estimated depth of the object.

15. The space area estimation apparatus according to claim 14, further comprising:
an own vehicle information understanding portion configured to acquire information regarding the vehicle and organize the information.

16. The space area estimation apparatus according to claim 14, further comprising:
a different vehicle information understanding portion configured to acquire information regarding a different vehicle and organize the information.

17. The space area estimation apparatus according to claim 14, further comprising:
a future information estimation portion configured to predict a future based on both of a latest image and a past image.

18. The space area estimation apparatus according to claim 14, wherein:
the space area estimation apparatus is communicably connected to a different vehicle or a cloud; and
the space area estimation apparatus is configured to transmit the area data in which an inside of the blind angle area is estimated to the different vehicle or the cloud.

19. A space area estimation apparatus communicatively connected to a capture portion mounted on a vehicle, the space area estimation apparatus comprising:
an image acquisition portion configured to acquire an image of an outside of the vehicle from the capture portion;
an operation circuit that is connected to the image acquisition portion and is configured to process the image acquired from the image acquisition portion; and
a memory that is connected to the operation circuit and is configured to store information utilized by the operation circuit for processing the image,
wherein:
the memory stores, as the information for processing the image,
a label database for adding a label to an object causing a blind angle in the image and
a depth information database for estimating a depth of the object to which the label is added; and
the operation circuit is configured to generate area data in which an inside of a blind angle area formed by the object is estimated based on the information of the depth of the object estimated based on the label database and the depth information database.

20. The space area estimation apparatus according to claim 19, further comprising:
an own vehicle information understanding portion configured to acquire the information regarding the vehicle and organize the information.

21. The space area estimation apparatus according to claim 19, further comprising:
a different vehicle information understanding portion configured to acquire the information regarding a different vehicle and organize the information.

22. The space area estimation apparatus according to claim 19, further comprising:
a future information estimation portion configured to predict a future based on both of a latest image and a past image.

23. The space area estimation apparatus according to claim 19, further comprising:
the space area estimation apparatus is communicably connected to a different vehicle or a cloud; and
the space area estimation apparatus is configured to transmit the area data in which an inside of the blind angle area is estimated to the different vehicle or the cloud.

24. The vehicle system according to claim 1, wherein:
the capture portion includes a camera;
the blind angle area estimation portion includes a processor; and
the depth of the object is a length of the object in parallel with a direction from the vehicle to the object.

25. The space area estimation apparatus according to claim 14,
the capture portion includes a camera;
the image acquisition portion includes a processor; and
the depth of the object is a length of the object in parallel with a direction from the vehicle to the object.

26. The space area estimation apparatus according to claim 19,
the capture portion includes a camera;
the image acquisition portion includes a processor; and
the depth of the object is a length of the object in parallel with a direction from the vehicle to the object.
